(19) United States
(12) Patent Application Publication
(10) Pub. No.: US 2021/0010822 A1
(43) Pub. Date: Jan. 14, 2021

(54) NOTIFICATION CONTROL DEVICE AND NOTIFICATION CONTROL METHOD

(71) Applicant: Mitsubishi Electric Corporation, Tokyo (JP)

(72) Inventor: Tomotsugu YAMAGUCHI, Tokyo (JP)

(73) Assignee: Mitsubishi Electric Corporation, Tokyo (JP)

(21) Appl. No.: 16/981,406

(22) PCT Filed: Apr. 20, 2018
(86) PCT No.: PCT/JP2018/016236

§ 371 Date: Sep. 16, 2020

(51) Int. Cl. G01C 21/36; G09G 5/36

(52) U.S. Cl. CPC G01C 21/3644; G09G 2380/10; G01C 21/3632; G09G 5/36

(57) ABSTRACT

A notification control device includes an inducing point determining unit that determines whether an inducing point of a longitudinal slope illusion is included in a planned travel region of a vehicle; and a notification control unit that performs control to notify a person on board the vehicle of inducing point information about the inducing point when it is determined that the inducing point is included in the planned travel region.

### TECHNICAL FIELD

The present invention relates to a notification control device and a notification control method.

### BACKGROUND ART

During vehicle travel, on continuing first and second road surfaces, due to an inclination angle of the second road surface with respect to the first road surface differing from an inclination angle of the second road surface with respect to a horizontal plane, a so-called “longitudinal slope illusion” may occur. By the occurrence of the longitudinal slope illusion, for example, despite the fact that the second road surface is downhill, the illusion that the second road surface is uphill is produced, by which the amount of stepping on an accelerator pedal increases, causing overspeed on the second road surface. Alternatively, for example, despite the fact that the second road surface is uphill, the illusion that the second road surface is downhill is produced, by which the amount of stepping on the accelerator pedal decreases, causing insufficient speed on the second road surface.

Conventionally, there is developed a technique in which a determination is made as to whether a point that a vehicle is currently traveling (hereinafter, referred to as “traveling point”) is a point that induces of a longitudinal slope illusion (hereinafter, referred to as “optical illusion-inducing point” or “inducing point”), and when it is determined that the traveling point is an optical illusion-inducing point, such a fact is notified to a driver (see, for example, Patent Literature 1).

### CITATION LIST

### Patent Literatures

Patent Literature 1: JP 2017-191369 A

### SUMMARY OF INVENTION

### Technical Problem

Conventional techniques described in Patent Literature 1, etc., determine whether a traveling point is an optical illusion-inducing point, but do not determine beforehand whether a point that the vehicle is planned to travel (hereinafter, referred to as “planned travel point”) is an optical illusion-inducing point. Hence, notification timing may be delayed relative to timing of occurrence of a longitudinal slope illusion. As a result, an operation on the accelerator pedal, etc., after notification cannot be performed at the right time, causing a problem that occurrence of overspeed, insufficient speed, or the like, on the second road surface cannot be prevented.

The present invention is made to solve a problem such as that described above, and an object of the present invention is to provide a notification control device and a notification control method that can determine whether a planned travel point is an optical illusion-inducing point and can provide notification when it is determined that the planned travel point is an optical illusion-inducing point.

### Solution to Problem

A notification control device of the present invention includes an inducing point determining unit for determining whether an inducing point of a longitudinal slope illusion is included in a planned travel region of a vehicle; and a notification control unit for performing control to notify a person on board the vehicle of inducing point information about the inducing point when it is determined that the inducing point is included in the planned travel region.

### Advantageous Effects of Invention

According to the present invention, since it is configured in the above-described manner, a determination as to whether a planned travel point is an optical illusion-inducing point can be made, and notification can be provided when it is determined that the planned travel point is an optical illusion-inducing point.

### BRIEF DESCRIPTION OF DRAWINGS

FIG. 1 is a block diagram showing a state in which a notification control device according to a first embodiment is provided on a vehicle.

FIG. 2A is an explanatory diagram showing an example of a captured image before a binarization process, FIG. 2B is an explanatory diagram showing an example of a captured image after the binarization process, FIG. 2C is an explanatory diagram showing an example of edges detected by an edge detection process, and FIG. 2D is an explanatory diagram showing an example of an angle between the edges.

FIG. 3A is an explanatory diagram showing an example of an optical illusion-inducing point in a first pattern, and FIG. 3B is an explanatory diagram showing an example of a notification image corresponding to the optical illusion-inducing point in the first pattern.

FIG. 4A is an explanatory diagram showing an example of an optical illusion-inducing point in a second pattern, and FIG. 4B is an explanatory diagram showing an example of a notification image corresponding to the optical illusion-inducing point in the second pattern.

FIG. 5A is an explanatory diagram showing an example of an optical illusion-inducing point in a third pattern, and FIG. 5B is an explanatory diagram showing an example of a notification image corresponding to the optical illusion-inducing point in the third pattern.

FIG. 6A is an explanatory diagram showing an example of an optical illusion-inducing point in a fourth pattern, and FIG. 6B is an explanatory diagram showing an example of a notification image corresponding to the optical illusion-inducing point in the fourth pattern.

FIG. 7A is a block diagram showing a hardware configuration of the notification control device according to the first embodiment, and FIG. 7B is a block diagram showing another hardware configuration of the notification control device according to the first embodiment.

FIG. 8 is a flowchart showing operation of the notification control device according to the first embodiment.

FIG. 9 is a block diagram showing a state in which another notification control device according to the first embodiment is provided on the vehicle.

FIG. 10 is a block diagram showing a state in which another notification control device according to the first embodiment is provided on the vehicle.

FIG. 11 is a block diagram showing a state in which a notification control device according to a second embodiment is provided on the vehicle.

FIG. 12 is a flowchart showing operation of the notification control device according to the second embodiment.

FIG. 13 is a block diagram showing a state in which another notification control device according to the second embodiment is provided on the vehicle.

FIG. 14 is a block diagram showing a state in which another notification control device according to the second embodiment is provided on the vehicle.

FIG. 15 is a block diagram showing a state in which another notification control device according to the second embodiment is provided on the vehicle.

FIG. 16 is a block diagram showing a state in which another notification control device according to the second embodiment is provided on the vehicle.

### DESCRIPTION OF EMBODIMENTS

To describe the invention in more detail, modes for carrying out the invention will be described below with reference to the accompanying drawings.

### First Embodiment

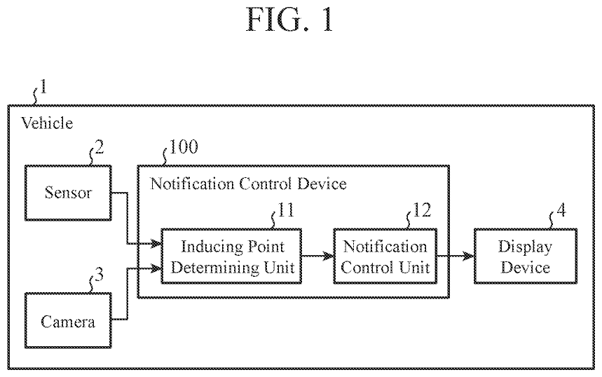

FIG. 1 is a block diagram showing a state in which a notification control device according to a first embodiment is provided on a vehicle. With reference to FIG. 1, a notification control device 100 of the first embodiment will be described.

In the following description, it is assumed that the unit of angle is degrees)(°) unless otherwise particularly specified. In addition, it is assumed that an inclination angle corresponding to an upward slope is calculated as a positive value, and an inclination angle corresponding to a downward slope is calculated as a negative value.

A vehicle 1 includes a sensor 2. The sensor 2 includes, for example, a so-called “three-axis” acceleration sensor or gyro sensor. In addition, the vehicle 1 includes a camera 3 for front capturing. The camera 3 includes, for example, a visible camera or an infrared camera.

An inducing point determining unit 11 determines whether an optical illusion-inducing point is included in a region in a predetermined area in front of the vehicle 1 (hereinafter, referred to as “planned travel region”), using a detection value obtained by the sensor 2 and a captured image I1 obtained by the camera 3. The planned travel region of the first embodiment corresponds, for example, to an area that can be captured by the camera 3.

More specifically, the inducing point determining unit 11 determines, by the following method, whether a point P between a road surface on which the vehicle 1 is currently traveling (hereinafter, referred to as “traveling road surface”) R1 and a road surface on which the vehicle 1 is planned to travel after the traveling road surface R1 (hereinafter, referred to as “planned travel road surface”) R2 is an optical illusion-inducing point. The point P is included in the planned travel region, and is a point that the vehicle 1 is planned to travel, i.e., a planned travel point.

First, the inducing point determining unit 11 calculates an inclination angle of the traveling road surface R1 with respect to a horizontal plane H (hereinafter, referred to as “first absolute inclination angle” or “absolute inclination angle”) θ1, using a detection value obtained by the sensor 2. For a calculation method for the first absolute inclination angle θ1, various known methods can be used, and a detailed description thereof is omitted.

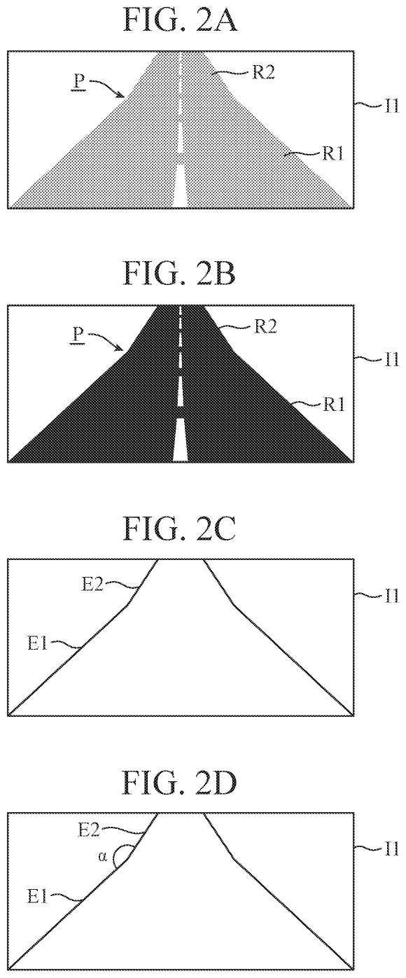

Then, the inducing point determining unit 11 detects an edge El corresponding to the traveling road surface R1 and an edge E2 corresponding to the planned travel road surface R2 by performing a binarization process and an edge detection process on the captured image I1. FIG. 2A shows an example of the captured image I1 before a binarization process. FIG. 2B shows an example of the captured image I1 after the binarization process. FIG. 2C shows an example of the edges E1 and E2 detected by an edge detection process.

Then, the inducing point determining unit 11 calculates an angle α between the edges E1 and E2. FIG. 2D shows an example of the angle α between the edges E1 and E2.

Then, the inducing point determining unit 11 calculates an angle θ2 between the traveling road surface R1 and the planned travel road surface R2 by multiplying the angle α between the edges E1 and E2 by a predetermined coefficient β. The coefficient β is preset according to the installation angle of the camera 3 on the vehicle 1, etc.

Then, the inducing point determining unit 11 calculates an inclination angle of the planned travel road surface R2 with respect to the traveling road surface R1 (hereinafter, referred to as “relative inclination angle”) θ3 by subtracting, for example, the angle θ2 from 180°.

Then, the inducing point determining unit 11 calculates an inclination angle of the planned travel road surface R2 with respect to the horizontal plane H (hereinafter, referred to as “second absolute inclination angle” or “absolute inclination angle”) θ4. Namely, when θ1≥0° and θ1+θ2>180°, the inducing point determining unit 11 calculates the second absolute inclination angle θ4 by θ4=θ1−θ3. In addition, when θ1≥0° and θ1+θ2=180°, the inducing point determining unit 11 calculates the second absolute inclination angle θ4 by θ4=0°. In addition, when θ1≥0° and θ1+θ2<180°, the inducing point determining unit 11 calculates the second absolute inclination angle θ4 by θ4=θ3−θ1. In addition, when θ1<0°, the inducing point determining unit 11 calculates the second absolute inclination angle θ4 by θ4=θ1+θ3.

Then, the inducing point determining unit 11 compares the angle α between the edges E1 and E2 with a predetermined threshold value αₜₕ. In addition, the inducing point determining unit 11 determines whether the traveling road surface R1 is uphill and determines whether the traveling road surface R1 is downhill, on the basis of whether the first absolute inclination angle θ1 is positive or negative. In addition, the inducing point determining unit 11 compares a difference value between the first absolute inclination angle θ1 and the relative inclination angle θ3 (θ1−θ3) with a zero value.

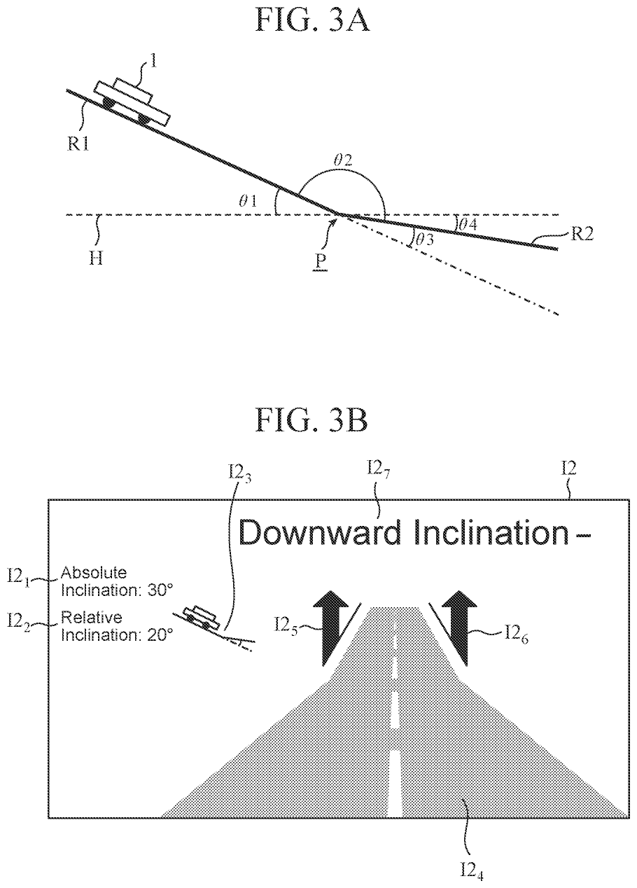

When conditions that the angle α is greater than or equal to the threshold value αₜₕ, the traveling road surface R1 is downhill, and the difference value (θ1−θ3) is a positive value (hereinafter, referred to as “first conditions”) hold true, the inducing point determining unit 11 determines that the point P between the traveling road surface R1 and the planned travel road surface R2 is an optical illusion-inducing point. A pattern of an optical illusion-inducing point based on the first conditions is hereinafter referred to as “first pattern”. FIG. 3A shows an example of an optical illusion-inducing point in the first pattern.

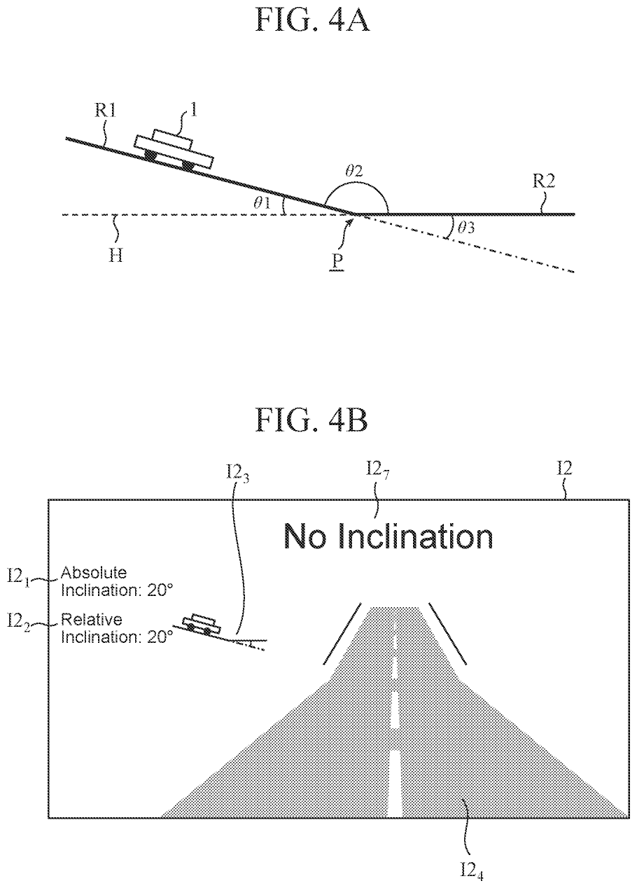

In addition, when conditions that the angle α is greater than or equal to the threshold value αₜₕ, the traveling road surface R1 is downhill, and the difference value (θ1−θ3) is the zero value (hereinafter, referred to as “second conditions”) hold true, the inducing point determining unit 11 determines that the point P between the traveling road surface R1 and the planned travel road surface R2 is an optical illusion-inducing point. A pattern of an optical illusion-inducing point based on the second conditions is hereinafter referred to as “second pattern”. FIG. 4A shows an example of an optical illusion-inducing point in the second pattern.

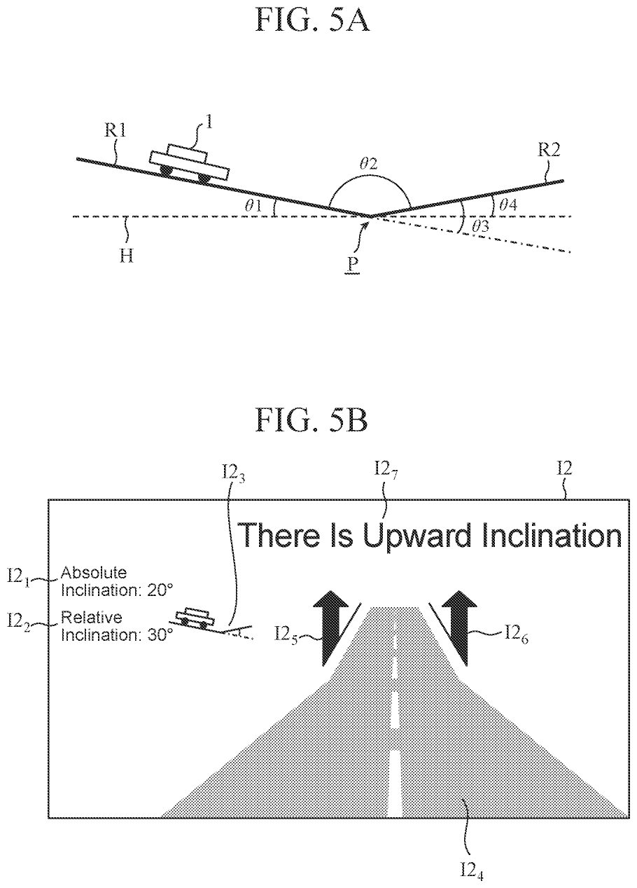

In addition, when conditions that the angle α is greater than or equal to the threshold value αₜₕ, the traveling road surface R1 is downhill, and the difference value (θ1−θ3) is a negative value (hereinafter, referred to as “third conditions”) hold true, the inducing point determining unit 11 determines that the point P between the traveling road surface R1 and the planned travel road surface R2 is an optical illusion-inducing point. A pattern of an optical illusion-inducing point based on the third conditions is hereinafter referred to as “third pattern”. FIG. 5A shows an example of an optical illusion-inducing point in the third pattern.

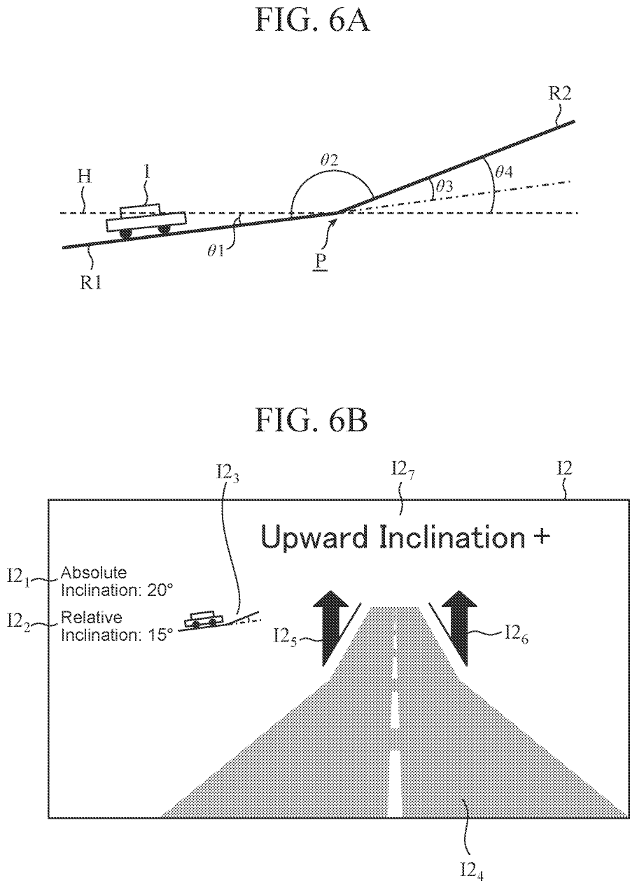

In addition, when conditions that the angle α is greater than or equal to the threshold value αₜₕ and the traveling road surface R1 is uphill (hereinafter, referred to as “fourth conditions”) hold true, the inducing point determining unit 11 determines that the point P between the traveling road surface R1 and the planned travel road surface R2 is an optical illusion-inducing point. A pattern of an optical illusion-inducing point based on the fourth conditions is hereinafter referred to as “fourth pattern”. FIG. 6A shows an example of an optical illusion-inducing point in the fourth pattern.

Namely, when the angle α is greater than or equal to the threshold value αₜₕ, the inducing point determining unit 11 determines that the point P is an optical illusion-inducing point in any of the patterns. On the other hand, when the angle α is less than the threshold value αₜₕ, the inducing point determining unit 11 determines that the point P is not an optical illusion-inducing point.

When it is determined that an optical illusion-inducing point is included in the planned travel region, i.e., when it is determined that the point P is an optical illusion-inducing point, the inducing point determining unit 11 generates information about the optical illusion-inducing point (hereinafter, referred to as “optical illusion-inducing point information” or “inducing point information”). The inducing point determining unit 11 outputs the optical illusion-inducing point information to a notification control unit 12.

The optical illusion-inducing point information includes, for example, information indicating the value of the first absolute inclination angle θ1, information indicating the value of the relative inclination angle θ3, information indicating the value of the second absolute inclination angle θ4, information indicating an inclination direction of the traveling road surface R1 with respect to the horizontal plane H (hereinafter, referred to as “first absolute inclination direction” or “absolute inclination direction”) D1, information indicating an inclination direction of the planned travel road surface R2 with respect to the traveling road surface R1 (hereinafter, referred to as “relative inclination direction”) D2, and information indicating an inclination direction of the planned travel road surface R2 with respect to the horizontal plane H (hereinafter, referred to as “second absolute inclination direction” or “absolute inclination direction”) D3.

When it is determined, by the inducing point determining unit 11, that an optical illusion-inducing point is included in the planned travel region, i.e., when it is determined that the point P is an optical illusion-inducing point, the notification control unit 12 performs control to notify a person on board the vehicle 1 (including a driver; hereinafter, the same) of the optical illusion-inducing point information.

More specifically, the notification control unit 12 performs control to display an image including the optical illusion-inducing point information (hereinafter, referred to as “notification image”) I2 on a display device 4. The display device 4 includes, for example, a Liquid Crystal Display (LCD), an Organic Electro-Luminescence Display (OLED), or a Head-Up Display (HUD).

FIG. 3B shows an example of a notification image I2 corresponding to an optical illusion-inducing point in the first pattern. FIG. 4B shows an example of a notification image I2 corresponding to an optical illusion-inducing point in the second pattern. FIG. 5B shows an example of a notification image I2 corresponding to an optical illusion-inducing point in the third pattern. FIG. 6B shows an example of a notification image I2 corresponding to an optical illusion-inducing point in the fourth pattern.

As shown in FIGS. 3B, 4B, 5B, and 6B, the notification image I2 includes an image I2₁ in text form representing the value of the first absolute inclination angle θ1 (display of a positive/negative sign of the value is omitted). In addition, the notification image I2 includes an image I2₂ in text form representing the value of the relative inclination angle θ3 (display of a positive/negative sign of the value is omitted). In addition, the notification image I2 includes an image I2₃ in illustration form representing a side shape of the vehicle 1 and cross-sectional shapes of the traveling road surface R1 and the planned travel road surface R2. In addition, the notification image I2 includes an image I2₄ in illustration form corresponding to the traveling road surface R1 and the planned travel road surface R2 in the captured image I1. In addition, the notification image I2 includes arrow-shaped images I2₅ and I2₆ representing the relative inclination direction D2. In addition, the notification image I2 includes an image I2₇ in text form representing inclination states of the traveling road surface R1 and the planned travel road surface R2 or an inclination state of the planned travel road surface R2.

The text “Downhill−” in the image I2₇ shown in FIG. 3B indicates that both the traveling road surface R1 and the planned travel road surface R2 are downhill, and a downward slope of the planned travel road surface R2 is smaller than a downward slope of the traveling road surface R1.

The text “No inclination” in the image I2₇ shown in FIG. 4B indicates that the planned travel road surface R2 is not a hill. The notification image I2 corresponding to an optical illusion-inducing point in the second pattern does not exceptionally include arrow-shaped images I2₅ and I2₆ representing the relative inclination direction D2.

The text “There is upward inclination” in the image I2₇ shown in FIG. 5B indicates that the planned travel road surface R2 is uphill.

The text “Uphill+” in the image I2₇ shown in FIG. 6B indicates that both the traveling road surface R1 and the planned travel road surface R2 are uphill, and an upward slope of the planned travel road surface R2 is larger than an upward slope of the traveling road surface R1.

The inducing point determining unit 11 and the notification control unit 12 form the main part of the notification control device 100.

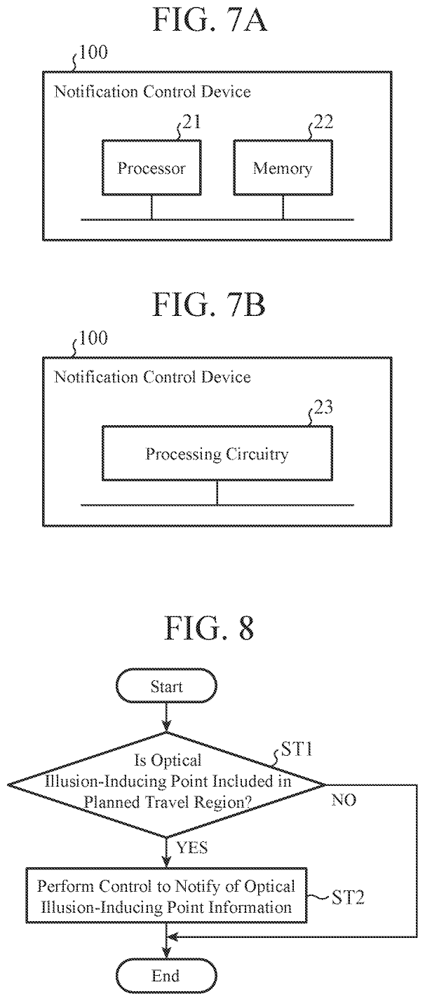

Next, with reference to FIG. 7, a hardware configuration of the main part of the notification control device 100 will be described.

As shown in FIG. 7A, the notification control device 100 includes a computer, and the computer includes a processor 21 and a memory 22. The memory 22 stores therein a program for causing the computer to function as the inducing point determining unit 11 and the notification control unit 12. By the processor 21 reading and executing the program stored in the memory 22, the functions of the inducing point determining unit 11 and the notification control unit 12 are implemented.

Alternatively, as shown in FIG. 7B, the notification control device 100 may include a processing circuitry 23. In this case, the functions of the inducing point determining unit 11 and the notification control unit 12 may be implemented by the processing circuitry 23.

Alternatively, the notification control device 100 may include the processor 21, the memory 22, and the processing circuitry 23. In this case, part of the functions of the inducing point determining unit 11 and the notification control unit 12 may be implemented by the processor 21 and the memory 22, and the remaining functions may be implemented by the processing circuitry 23.

The processor 21 uses, for example, a Central Processing Unit (CPU), a Graphics Processing Unit (GPU), a microprocessor, a microcontroller, or a Digital Signal Processor (DSP).

The memory 22 uses, for example, a semiconductor memory or a magnetic disk. More specifically, the memory 22 uses a Random Access Memory (RAM), a Read Only Memory (ROM), a flash memory, an Erasable Programmable Read Only Memory (EPROM), an Electrically Erasable Programmable Read-Only Memory (EEPROM), a Solid State Drive (SSD), a Hard Disk Drive (HDD), or the like.

The processing circuitry 23 uses, for example, an Application Specific Integrated Circuit (ASIC), a Programmable Logic Device (PLD), a Field-Programmable Gate Array (FPGA), a System-on-a-Chip (SoC), or a system Large-Scale Integration (LSI).

Next, with reference to a flowchart of FIG. 8, operation of the notification control device 100 will be described. The notification control device 100, for example, repeatedly performs processes shown in FIG. 8 in a state in which power to the notification control device 100 is turned on.

First, at step ST1, the inducing point determining unit 11 determines whether an optical illusion-inducing point is included in a planned travel region, using a detection value obtained by the sensor 2 and a captured image I1 obtained by the camera 3. More specifically, the inducing point determining unit 11 determines whether a point P between a traveling road surface R1 and a planned travel road surface R2 is an optical illusion-inducing point. Details of a determination method used by the inducing point determining unit 11 are as already described, and thus, repeated description thereof is omitted.

When it is determined that an optical illusion-inducing point is included in the planned travel region, i.e., when it is determined that the point P between the traveling road surface R1 and the planned travel road surface R2 is an optical illusion-inducing point (“YES” at step ST1), at step ST2, the notification control unit 12 performs control to notify a person on board the vehicle 1 of optical illusion-inducing point information. More specifically, the notification control unit 12 performs control to display a notification image I2 on the display device 4. Details of the notification image I2 are as already described, and thus, repeated description thereof is omitted.

As such, the notification control device 100 of the first embodiment can determine whether a point P in a planned travel region is an optical illusion-inducing point beforehand (i.e., prior to the vehicle 1 passing the point P). In addition, when it is determined that the point P is an optical illusion-inducing point, optical illusion-inducing point information about the point P can be notified to a person on board the vehicle 1 beforehand (i.e., prior to the vehicle 1 passing the point P). By this, prior to the vehicle 1 passing the point P, a driver of the vehicle 1 can be prompted to perform an operation on an accelerator pedal, etc., based on a slope of the planned travel road surface R2 (i.e., a second absolute inclination angle θ4). As a result, overspeed, insufficient speed, or the like, caused by a longitudinal slope illusion can be prevented from occurring on the planned travel road surface R2. Alternatively, occurrence of a longitudinal slope illusion itself can be prevented.

In addition, by displaying notification images I2 such as those shown in FIGS. 3B, 4B, 5B, and 6B on the display device 4, the driver of the vehicle 1 can predict traffic conditions (e.g., a congested condition on an uphill) on the planned travel road surface R2. By this, the driver of the vehicle 1 can be prompted to drive (e.g., acceleration or deceleration) according to traffic conditions on the planned travel road surface R2.

Note that a determination method used by the inducing point determining unit 11 is not limited to the above-described specific example. The inducing point determining unit 11 may first calculate an angle a, and then compare the angle α with the threshold value αₜₕ, and when the angle α is greater than or equal to the threshold value αₜₕ, the inducing point determining unit 11 may determine that the point P is an optical illusion-inducing point, and when the angle α is less than the threshold value αₜₕ, the inducing point determining unit 11 may determine that the point P is not an optical illusion-inducing point. Thereafter, only when the angle α is greater than or equal to the threshold value αₜₕ, the inducing point determining unit 11 may determine a pattern of the point P by calculating a first absolute inclination angle θ1 and a relative inclination angle θ3, and generate optical illusion-inducing point information by calculating a second absolute inclination angle θ4.

Namely, a determination as to whether the point P is an optical illusion-inducing point may not use a detection value obtained by the sensor 2 (i.e., only a captured image I1 obtained by the camera 3 may be used). A detection value obtained by the sensor 2 may be used exclusively to calculate a first absolute inclination angle θ1.

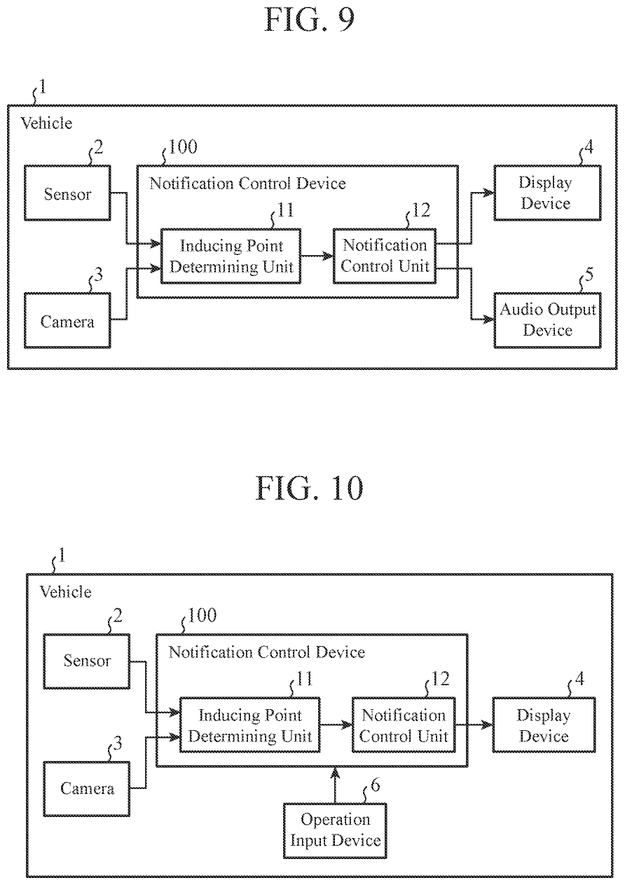

In addition, notification by the notification control unit 12 is not limited to display of a notification image I2. The notification control unit 12 may perform control to cause an audio output device 5 to output audio including optical illusion-inducing point information (hereinafter, referred to as “notification audio”) (see FIG. 9). The audio output device 5 includes, for example, a speaker.

In addition, the inducing point determining unit 11 may use, as a determination target, at least one of optical illusion-inducing points in a plurality of patterns (i.e., the first to fourth patterns). In this case, a pattern of an optical illusion-inducing point serving as the determination target of the inducing point determining unit 11 may be freely settable by operation input to an operation input device 6 (see FIG. 10). The operation input device 6 includes, for example, a touch panel integrally formed with the display device 4 or a hardware key provided adjacent to the display device 4.

In addition, the notification control unit 12 may determine whether the relative inclination angle θ3 has a value greater than or equal to a predetermined angle (hereinafter, referred to as “reference angle”), using optical illusion-inducing point information. The notification control unit 12 may perform control to notify of optical illusion-inducing point information only when the relative inclination angle θ3 has a value greater than or equal to the reference angle. By this, the driver of the vehicle 1 can be informed of optical illusion-inducing point information about a point P with a large relative inclination angle θ3.

In addition, the notification control unit 12 may determine whether the relative inclination angle θ3 has a value in a predetermined range (hereinafter, referred to as “reference range”), using optical illusion-inducing point information. The notification control unit 12 may perform control to notify of optical illusion-inducing point information only when the relative inclination angle θ3 has a value in the reference range. In this case, the reference range may be freely settable by operation input to the operation input device 6 (see FIG. 10). By this, unnecessary notification can be suppressed from being outputted to the driver of the vehicle 1.

In addition, a notification image I2 may be any image as long as the notification image I2 includes at least a part of optical illusion-inducing point information, and is not limited to the specific examples shown in FIGS. 3B, 4B, 5B, and 6B. For example, the notification image I2 may include one or more images among the plurality of images I2₁ to I2₇.

In addition, the notification control unit 12 may allow a display mode of the arrow-shaped images I2₅ and I2₆ to vary depending on the value of the relative inclination angle θ3. Specifically, for example, the notification control unit 12 may allow at least one of the length, thickness, size, and color of the arrow-shaped images I2₅ and I2₆ to vary depending on the value of the relative inclination angle θ3.

For the length of the arrow-shaped images I2₅ and I2₆, the notification control unit 12 may increase the length of the arrows as the relative inclination angle θ3 increases. For the thickness of the arrow-shaped images I2₅ and I2₆, the notification control unit 12 may increase the thickness of the arrows as the relative inclination angle θ3 increases. For the size of the arrow-shaped images I2₅ and I2₆, the notification control unit 12 may increase the size of the arrows as the relative inclination angle θ3 increases.

In addition, the notification image I2 may include arrow-shaped images I2₈ and I2₉ (not shown) representing the second absolute inclination direction D3, instead of the arrow-shaped images I2₅ and I2₆ representing the relative inclination direction D2. Particularly, when the notification image I2 does not include an image representing cross-sectional shapes of the traveling road surface R1 and the planned travel road surface R2 (e.g., the image I2₃ in illustration form), it is preferred to display the arrow-shaped images I2₈ and I2₉ from the point of view of informing the driver of the vehicle 1 of the second absolute inclination direction D3.

In addition, the notification control unit 12 may allow a display mode of the arrow-shaped images I2₈ and I2₉ to vary depending on the value of the second absolute inclination angle θ4. Specifically, for example, the notification control unit 12 may allow at least one of the length, thickness, size, and color of the arrow-shaped images I2₈ and I2₉ to vary depending on the value of the second absolute inclination angle θ4.

For the length of the arrow-shaped images I2₈ and I2₉, the notification control unit 12 may increase the length of the arrows as the second absolute inclination angle θ4 increases. For the thickness of the arrow-shaped images I2₈ and I2₉, the notification control unit 12 may increase the thickness of the arrows as the second absolute inclination angle θ4 increases. For the size of the arrow-shaped images I2₈ and I2₉, the notification control unit 12 may increase the size of the arrows as the second absolute inclination angle θ4 increases.

In addition, the content of optical illusion-inducing point information may be any content as long as the content is based on the content of a notification image I2, and the content is not limited to the above-described specific examples.

As described above, the notification control device 100 of the first embodiment includes the inducing point determining unit 11 that determines whether an inducing point of a longitudinal slope illusion is included in a planned travel region of the vehicle 1; and the notification control unit 12 that performs control to notify a person on board the vehicle 1 of inducing point information about the inducing point when it is determined that the inducing point is included in the planned travel region. By this, occurrence of overspeed, insufficient speed, or the like, caused by a longitudinal slope illusion can be prevented. Alternatively, occurrence of a longitudinal slope illusion itself can be prevented.

In addition, the inducing point determining unit 11 determines whether a point P between a traveling road surface R1 of the vehicle 1 and a planned travel road surface R2 of the vehicle 1 is an inducing point. By this, prior to the vehicle 1 passing the point P, a driver of the vehicle 1 can be informed of the fact that the point P is an optical illusion-inducing point.

In addition, the inducing point determining unit 11 calculates a relative inclination angle θ3 which is an inclination angle of the planned travel road surface R2 with respect to the traveling road surface R1, and the inducing point information includes information indicating the value of the relative inclination angle θ3. By this, for example, an image based on the relative inclination angle θ3 (an image I2₂ in text form, arrow-shaped images I2₅ and I2₆, and the like) can be included in a notification image I2.

In addition, the inducing point determining unit 11 calculates a first absolute inclination angle θ1 which is an inclination angle of the traveling road surface R1 with respect to a horizontal plane H, and the inducing point information includes information indicating the value of the first absolute inclination angle θ1. By this, for example, an image based on the first absolute inclination angle θ1 (an image I2₁ in text form, etc.) can be included in the notification image I2.

In addition, the inducing point determining unit 11 calculates a second absolute inclination angle θ4 which is an inclination angle of the planned travel road surface R2 with respect to the horizontal plane H, and the inducing point information includes information indicating the value of the second absolute inclination angle θ4. By this, for example, an image based on the second absolute inclination angle θ4 (arrow-shaped images I2₈ and I2₉, etc.) can be included in the notification image I2.

In addition, the inducing point determining unit 11 uses, as a determination target, at least one of inducing points in a plurality of patterns, and a pattern of an inducing point serving as the determination target of the inducing point determining unit 11 is freely settable by operation input to the operation input device 6. By reducing the number of patterns of inducing points serving as a determination target, the number of times notification is outputted during driving can be reduced. As a result, annoyance that the driver of the vehicle 1 feels about notification can be reduced.

In addition, the notification control unit 12 performs control to display an image I2₃ representing cross-sectional shapes of the traveling road surface R1 and the planned travel road surface R2 on the display device 4. By this, compared to a case of displaying, for instance, only images I2₁ and I2₂ in text form, the first absolute inclination angle θ1, the relative inclination angle θ3, and the like, can be displayed in a visually easy-to-understand manner.

In addition, the inducing point information includes information indicating a relative inclination direction D2 which is an inclination direction of the planned travel road surface R2 with respect to the traveling road surface R1, and the notification control unit 12 performs control to display arrow-shaped images I2₅ and I2₆ representing the relative inclination direction D2 on the display device 4. By this, the relative inclination direction D2 can be displayed in a visually easy-to-understand manner.

In addition, the notification control unit 12 allows a display mode of the arrow-shaped images I2₅ and I2₆ to vary depending on the value of the relative inclination angle θ3. By this, the relative inclination angle θ3 can be displayed in a visually further easy-to-understand manner.

In addition, the inducing point information includes information indicating a second absolute inclination direction D3 which is an inclination direction of the planned travel road surface R2 with respect to the horizontal plane H, and the notification control unit 12 performs control to display arrow-shaped images I28 and 129 representing the second absolute inclination direction D3 on the display device 4. By this, the second absolute inclination direction D3 can be displayed in a visually easy-to-understand manner.

In addition, the notification control unit 12 allows a display mode of the arrow-shaped images I2₈ and I2₉ to vary depending on the value of the second absolute inclination angle θ4. By this, the second absolute inclination angle θ4 can be displayed in a visually easy-to-understand manner.

In addition, the notification control unit 12 performs control to notify of the inducing point information when the relative inclination angle θ3 has a value in a reference range, and the reference range is freely settable by operation input to the operation input device 6. By this, unnecessary notification can be prevented from being outputted to the driver of the vehicle 1.

In addition, a notification control method of the first embodiment includes step ST1 of determining, by the inducing point determining unit 11, whether an inducing point of a longitudinal slope illusion is included in a planned travel region of the vehicle 1; and step ST2 of performing, by the notification control unit 12, control to notify a person on board the vehicle 1 of inducing point information about the inducing point when it is determined that the inducing point is included in the planned travel region. By this, the same advantageous effects as the above-described advantageous effects obtained by the notification control device 100 can be obtained.

### Second Embodiment.

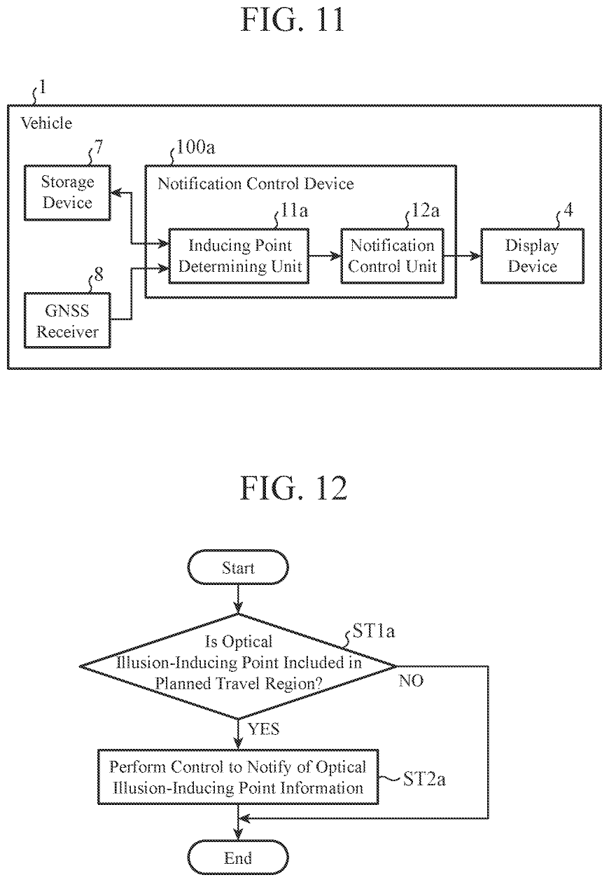

FIG. 11 is a block diagram showing a state in which a notification control device according to a second embodiment is provided on a vehicle. With reference to FIG. 11, a notification control device 100a of the second embodiment will be described. Note that in FIG. 11 the same blocks as those shown in FIG. 1 are given the same reference signs and description thereof is omitted.

A storage device 7 stores a database. The database (hereinafter, simply referred to as “database”) includes map information. In addition, the database includes information indicating a location of each of a plurality of optical illusion-inducing points (hereinafter, referred to as “optical illusion-inducing point location information”). In addition, the database includes a plurality of pieces of optical illusion-inducing point information having one-to-one correspondence with the plurality of optical illusion-inducing points.

Each of the plurality of pieces of optical illusion-inducing point information includes, for example, information indicating the value of a relative inclination angle θ3 at a corresponding optical illusion-inducing point; information indicating absolute inclination angles θ1 and θ4 at the corresponding optical illusion-inducing point; information indicating a relative inclination direction D2 at the corresponding optical illusion-inducing point; and information indicating absolute inclination directions D1 and D3 at the corresponding optical illusion-inducing point. Each of the plurality of pieces of optical illusion-inducing point information is, for example, generated in the past by notification control devices 100 (i.e., notification control devices 100 of the first embodiment) provided on other vehicles.

Here, each of the plurality of optical illusion-inducing points is a point between two continuing road surfaces R1 and R2. The relative inclination angle θ3 is an inclination angle of either one of the two road surfaces R1 and R2 with respect to the other road surface. The absolute inclination angle θ1 is an inclination angle of either one of the two road surfaces R1 and R2 with respect to a horizontal plane H, and the absolute inclination angle θ4 is an inclination angle of the other one of the two road surfaces R1 and R2 with respect to the horizontal plane H. The relative inclination direction D2 is an inclination direction of either one of the two road surfaces R1 and R2 with respect to the other road surface. The absolute inclination direction D1 is an inclination direction of either one of the two road surfaces R1 and R2 with respect to the horizontal plane H, and the absolute inclination direction D3 is an inclination direction of the other one of the two road surfaces R1 and R2 with respect to the horizontal plane H.

A Global Navigation Satellite System (GNSS) receiver 8 receives GNSS signals. The GNSS signals are transmitted by GNSS satellites which are not shown.

An inducing point determining unit 11a calculates a location of the vehicle 1 (hereinafter, referred to as “host vehicle location”) and a traveling direction of the vehicle 1, using the GNSS signals received by the GNSS receiver 8. The inducing point determining unit 11a sets a region in a predetermined area in front of the vehicle 1 (i.e., a planned travel region) on the basis of the calculated host vehicle location and traveling direction, using the map information in the database. The inducing point determining unit 11a determines whether an optical illusion-inducing point is included in the planned travel region, using the optical illusion-inducing point location information in the database.

When it is determined that a single optical illusion-inducing point is included in the planned travel region, the inducing point determining unit 11a obtains optical illusion-inducing point information corresponding to the single optical illusion-inducing point from the database. The inducing point determining unit 11a outputs the obtained optical illusion-inducing point information to a notification control unit 12a.

When it is determined that a plurality of optical illusion-inducing points are included in the planned travel region, the inducing point determining unit 11a selects one of the plurality of optical illusion-inducing points closest to the host vehicle location, and obtains optical illusion-inducing point information corresponding to the one optical illusion-inducing point from the database. The inducing point determining unit 11a outputs the obtained optical illusion-inducing point information to the notification control unit 12a.

When the inducing point determining unit 11a determines that an optical illusion-inducing point is included in the planned travel region, the notification control unit 12a performs control to notify a person on board the vehicle 1 of optical illusion-inducing point information outputted from the inducing point determining unit 11a. More specifically, the notification control unit 12a performs control to display a notification image I2 including the optical illusion-inducing point information on the display device 4. Details of the notification image I2 are the same as those described in the first embodiment, and thus, repeated description thereof is omitted.

The inducing point determining unit 11a and the notification control unit 12a form the main part of the notification control device 100a.

A hardware configuration of the main part of the notification control device 100a is the same as that described with reference to FIG. 7 in the first embodiment, and thus, depiction and description thereof are omitted. Namely, the function of each of the inducing point determining unit 11a and the notification control unit 12a may be implemented by the processor 21 and the memory 22 or may be implemented by the processing circuitry 23.

Next, with reference to a flowchart of FIG. 12, operation of the notification control device 100a will be described. The notification control device 100a, for example, repeatedly performs processes shown in FIG. 12 in a state in which power to the notification control device 100a is turned on.

First, at step ST1a, the inducing point determining unit 11a determines whether an optical illusion-inducing point is included in a planned travel region, using the database stored in the storage device 7 and GNSS signals received by the GNSS receiver 8. Details of a determination method used by the inducing point determining unit 11a are as already described, and thus, repeated description thereof is omitted.

When it is determined that an optical illusion-inducing point is included in the planned travel region (“YES” at step ST1a), at step ST2a, the notification control unit 12a performs control to notify a person on board the vehicle 1 of optical illusion-inducing point information which is outputted from the inducing point determining unit 11a. More specifically, the notification control unit 12 performs control to display a notification image I2 including the optical illusion-inducing point information on the display device 4. Details of the notification image I2 are the same as those described in the first embodiment, and thus, repeated description thereof is omitted.

As such, the notification control device 100a of the second embodiment can determine whether an optical illusion-inducing point is included in a planned travel region beforehand (i.e., prior to the vehicle 1 entering the planned travel region). In addition, when it is determined that an optical illusion-inducing point is included in the planned travel region, optical illusion-inducing point information about the optical illusion-inducing point can be notified to a person on board the vehicle 1 beforehand (i.e., prior to the vehicle 1 entering the planned travel region). By this, occurrence of overspeed, insufficient speed, or the like, caused by a longitudinal slope illusion can be prevented. Alternatively, occurrence of a longitudinal slope illusion itself can be prevented.

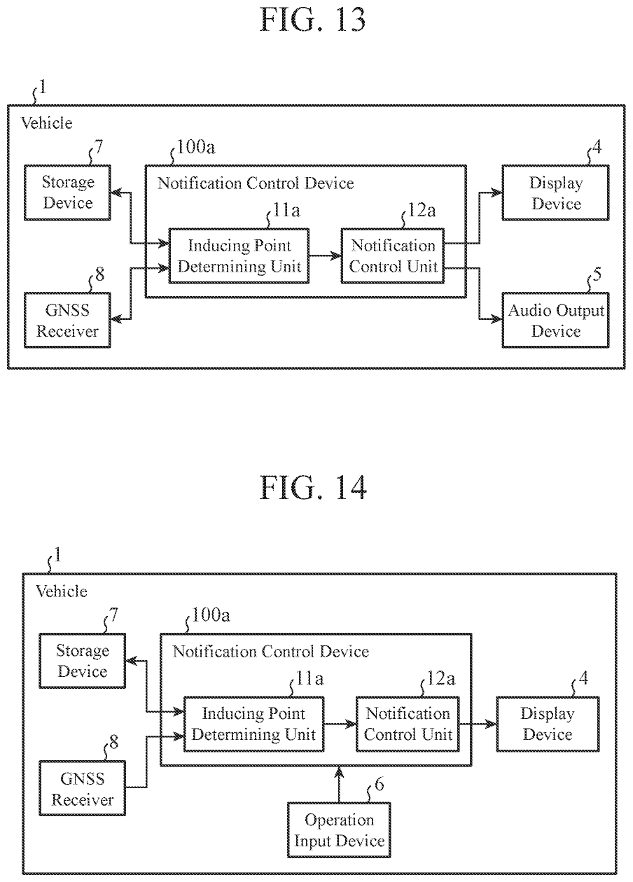

Note that notification by the notification control unit 12a is not limited to display of a notification image I2. The notification control unit 12a may perform control to cause the audio output device 5 to output audio including optical illusion-inducing point information which is outputted from the inducing point determining unit 11a, i.e., notification audio (see FIG. 13).

In addition, the inducing point determining unit 11a may use, as a determination target, at least one of optical illusion-inducing points in a plurality of patterns (i.e., the first to fourth patterns). In this case, a pattern of an optical illusion-inducing point serving as the determination target of the inducing point determining unit 11a may be freely settable by operation input to the operation input device 6 (see FIG. 14).

In addition, the notification control unit 12a may determine whether the relative inclination angle θ3 has a value greater than or equal to a reference angle, using optical illusion-inducing point information outputted from the inducing point determining unit 11a. The notification control unit 12a may perform control to notify of optical illusion-inducing point information outputted from the inducing point determining unit 11a only when the relative inclination angle θ3 has a value greater than or equal to the reference angle.

In addition, the notification control unit 12a may determine whether the relative inclination angle θ3 has a value in a reference range, using optical illusion-inducing point information outputted from the inducing point determining unit 11a. The notification control unit 12a may perform control to notify of optical illusion-inducing point information outputted from the inducing point determining unit 11a only when the relative inclination angle θ3 has a value in the reference range. In this case, the reference range may be freely settable by operation input to the operation input device 6 (see FIG. 14).

In addition to the above, the notification control device 100a can adopt the same various variants as those described in the first embodiment.

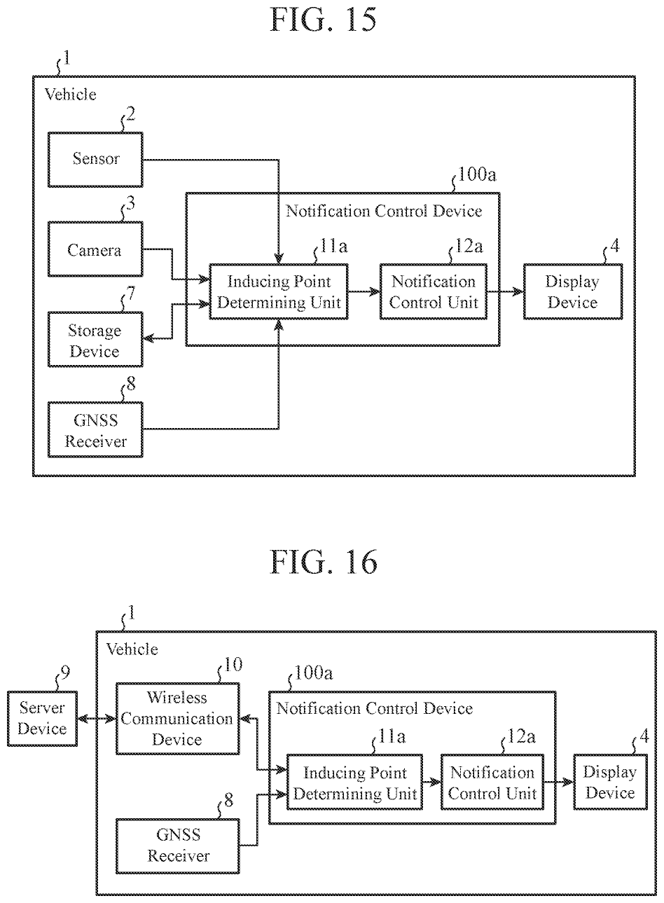

In addition, the vehicle 1 may include the sensor 2 and the camera 3, and the inducing point determining unit 11a may have the same function as the inducing point determining unit 11 (see FIG. 15). Namely, the notification control device 100a may have a function of determining whether an optical illusion-inducing point is included in a planned travel region, using a detection value obtained by the sensor 2 and a captured image I1 obtained by the camera 3 (more specifically, a function of determining whether a point P is an optical illusion-inducing point. Hereinafter, referred to as “second determination function”) in addition to a function of determining whether an optical illusion-inducing point is included in the planned travel region, using the database and GNSS signals (hereinafter, referred to as “first determination function”).

The inducing point determining unit 11a may first determine, by the first determination function, whether an optical illusion-inducing point is included in a planned travel region, and when a result of the determination by the first determination function is “NO”, the inducing point determining unit 11a may determine, by the second determination function, whether a point P is an optical illusion-inducing point. In addition, when it is determined, by the second determination function, that the point P is an optical illusion-inducing point, the inducing point determining unit 11a may generate optical illusion-inducing point location information and optical illusion-inducing point information corresponding to the point P, and add the generated optical illusion-inducing point location information and optical illusion-inducing point information to the database. By this, the database can be updated.

In addition, the database may be stored in a server device 9 external to the vehicle 1, instead of in the storage device 7 in the vehicle 1 (see FIG. 16). In this case, the inducing point determining unit 11a may obtain information in the database from the server device 9 using a wireless communication device 10 in the vehicle 1. The wireless communication device 10 may include a transmitter and a receiver for in-vehicle use or may include a portable information terminal such as a smartphone.

As described above, the notification control device 100a of the second embodiment includes the inducing point determining unit 11a that determines whether an inducing point of a longitudinal slope illusion is included in a planned travel region of the vehicle 1; and the notification control unit 12a that performs control to notify a person on board the vehicle 1 of inducing point information about the inducing point when it is determined that the inducing point is included in the planned travel region. By this, occurrence of overspeed, insufficient speed, or the like, caused by a longitudinal slope illusion can be prevented. Alternatively, occurrence of a longitudinal slope illusion itself can be prevented.

In addition, a notification control method of the second embodiment includes step ST1a of determining, by the inducing point determining unit 11a, whether an inducing point of a longitudinal slope illusion is included in a planned travel region of the vehicle 1; and step ST2a of performing, by the notification control unit 12a, control to notify a person on board the vehicle 1 of inducing point information about the inducing point when it is determined that the inducing point is included in the planned travel region. By this, the same advantageous effects as the above-described advantageous effects obtained by the notification control device 100a can be obtained.

Note that in the invention of this application, a free combination of the embodiments, modifications to any component of the embodiments, or omissions of any component in the embodiments are possible within the scope of the invention.

### INDUSTRIAL APPLICABILITY

A notification control device and a notification control method according to the present invention can be used to notify of information about an inducing point of a longitudinal slope illusion.

### REFERENCE SIGNS LIST

1: vehicle,
2: sensor,
3: camera,
4: display device,
5: audio output device,
6: operation input device,
7: storage device,
8: GNSS receiver,
9: server device,
10: wireless communication device,
11 and 11a: inducing point determining unit,
12 and 12a: notification control unit,
21: processor,
22: memory,
23: processing circuitry, and
100 and 100a: notification control device

1. (canceled)

2. The A notification control device according to claim 1, comprising:
processing circuitry
to determine whether an inducing point of a longitudinal slope illusion is included in a planned travel region of a vehicle; and
to perform control to notify a person on board the vehicle of inducing point information about the inducing point when it is determined that the inducing point is included in the planned travel region, wherein
the processing circuitry determines whether a point between a traveling road surface of the vehicle and a planned travel road surface of the vehicle is the inducing point.

3. The notification control device according to claim 2, wherein
the processing circuitry calculates a relative inclination angle, the relative inclination angle being an inclination angle of the planned travel road surface with respect to the traveling road surface, and
the inducing point information includes information indicating a value of the relative inclination angle.

4. The notification control device according to claim 2, wherein the processing circuitry calculates a first absolute inclination angle, the first absolute inclination angle being an inclination angle of the traveling road surface with respect to a horizontal plane, and
the inducing point information includes information indicating a value of the first absolute inclination angle.

5. The notification control device according to claim 2, wherein
the processing circuitry calculates a second absolute inclination angle, the second absolute inclination angle being an inclination angle of the planned travel road surface with respect to a horizontal plane, and
the inducing point information includes information indicating a value of the second absolute inclination angle.

6. A notification control device, comprising:
processing circuitry
to determine whether an inducing point of a longitudinal slope illusion is included in a planned travel region of a vehicle; and
to perform control to notify a person on board the vehicle of inducing point information about the inducing point when it is determined that the inducing point is included in the planned travel region, wherein
the processing circuitry uses, as a determination target, at least one of inducing points in a plurality of patterns, and
a pattern of an inducing point serving as the determination target of the processing circuitry is freely settable by operation input to an operation input device.

7. The notification control device according to claim 3, wherein the processing circuitry performs control to display an image on a display device, the image representing cross-sectional shapes of the traveling road surface and the planned travel road surface.

8. The notification control device according to claim 7, wherein
the inducing point information includes information indicating a relative inclination direction, the relative inclination direction being an inclination direction of the planned travel
the processing circuitry performs control to display an arrow-shaped image on the display device, the arrow-shaped image representing the relative inclination direction.

9. The notification control device according to claim 8, wherein the processing circuitry allows a display mode of the arrow-shaped image to vary depending on a value of the relative inclination angle.

10. The notification control device according to claim 9, wherein the processing circuitry allows at least one of a length, a thickness, a size, and color of the arrow-shaped image to vary depending on the value of the relative inclination angle.

11. The notification control device according to claim 5, wherein
the inducing point information includes information indicating a second absolute inclination direction, the second absolute inclination direction being an inclination direction of the planned travel road surface with respect to the horizontal plane, and
the processing circuitry performs control to display an arrow-shaped image on a display device, the arrow-shaped image representing the second absolute inclination direction.

12. The notification control device according to claim 11, wherein the processing circuitry allows a display mode of the arrow-shaped image to vary depending on a value of the second absolute inclination angle.

13. The notification control device according to claim 12, wherein the processing circuitry allows at least one of a length, a thickness, a size, and color of the arrow-shaped image to vary depending on the value of the second absolute inclination angle.

14. The notification control device according to claim 3, wherein
the processing circuitry performs control to notify of the inducing point information when the relative inclination angle has a value in a reference range, and
the reference range is freely settable by operation input to an operation input device.

15. A notification control method comprising:
determining whether an inducing point of a longitudinal slope illusion is included in a planned travel region of a vehicle; and
performing control to notify a person on board the vehicle of inducing point information about the inducing point when it is determined that the inducing point is included in the planned travel region, wherein
a determination is made whether a point between a traveling road surface of the vehicle and a planned travel road surface of the vehicle is the inducing point.
